(19) United States
(12) Patent Application Publication
(10) Pub. No.: US 2023/0070388 A1
(43) Pub. Date: Mar. 9, 2023

(54) SYSTEMS AND METHODS FOR LOSSLESS BROADBAND VIRTUAL PRIVATE NETWORK ACCESS

(71) Applicant: Masergy Communications, Inc., Philadelphia, PA (US)

(72) Inventors: Christopher MacFarland, Trophy Club, TX (US); Terry Traina, Allen, TX (US); Anthony Pardini, Richardson, TX (US); Roman Perez, McKinney, TX (US)

(73) Assignee: Masergy Communications, Inc., Philadelphia, PA (US)

(21) Appl. No.: 17/813,536

(22) Filed: Jul. 19, 2022

Related U.S. Application Data
(60) Provisional application No. 63/203,386, filed on Jul. 20, 2021.

(51) Int. Cl. H04L 9/40

(52) U.S. Cl. CPC H04L 63/0272; H04L 63/029; H04L 63/0236

(57) ABSTRACT

Systems and devices, and methods operable therein, to provide lossless broadband communications, via the Internet, between a Customer Premises Equipment (CPE) device and a Provider Edge (PE) Router associated with a Virtual Private Network. In a general embodiment, the method in the CPE device comprises establishing an IPSec tunnel with Forward Error Correction (FEC) between the CPE device and a Cloud Firewall (CFW) associated with the PE Router (the CFW and PE router can be distinct devices or integrated into a single device); receiving a plurality of egress packets from a Local Area Network (LAN), each of the egress packets comprising an Internet Protocol (IP) header and data payload, wherein the IP header identifies a destination address associated with the VPN; opening a data session and encapsulating each of the egress packets utilizing an encapsulation protocol to create encapsulated egress packets; encrypting each encapsulated egress packet to create encrypted encapsulated egress packets for transmission through the IPSec tunnel to the CFW; and, generating and transmitting Forward Error Correction (FEC) packets, together with the encrypted encapsulated egress packets, from the CPE device to the CFW.

### CROSS-REFERENCE TO RELATED APPLICATION

This application claims priority to U.S. Provisional Pat. Application Serial No. 63/203,386, filed Jul. 20, 2021, entitled SYSTEMS AND METHODS FOR LOSSLESS BROADBAND VIRTUAL PRIVATE NETWORK ACCESS, the disclosure of which is incorporated herein by reference.

### TECHNICAL FIELD OF THE DISCLOSURE

The present disclosure is directed, in general, to enterprise, or virtual private network (VPN) networking and, more specifically, to systems and methods to provide lossless broadband access to a VPN network.

### BACKGROUND

The growth in employees working from home has led to a huge spike in people using virtual private networks (VPNs) to connect to business information technology (IT) resources; the demand has only accelerated due to the Covid-19 pandemic. Most companies have become more dependent on broadband since the 2020 pandemic, but it has not always served them well -particularly in cases where guaranteed performance is needed. According to anAltman Solon 2021 State of SD-WAN Study, 50% of IT leaders using only public access say their application performance is insufficient, and 48% say the cost savings don’t justify the lower quality of service.

One of the fundamental problems for remote connectivity to a corporate wide area network (WAN) is the limitations of conventional broadband services to the home; although much cheaper than alternative services, typical broadband service is inherently a “best effort” technology unfit for real-time data applications like voice and video conferencing. Thus, conventional broadband often fails to deliver the performance needed, causing losses in productivity, sales, and revenue. The limitations of conventional broadband service can be overcome through utilization of an Ethernet private line (EPL), but EPL service comes at a significantly higher cost than broadband. Accordingly, there is a need in the art for systems and methods to provide enterprise VPN services with broadband access that meets the Quality of Service (QoS) expectations associated with EPL.

### SUMMARY

To address the deficiencies of the prior art, disclosed hereinafter are systems and devices, and methods operable therein, to provide lossless broadband communications, via the Internet, between a Customer Premises Equipment (CPE) device and a Provider Edge (PE) Router associated with a Virtual Private Network (VPN). In a general embodiment, for egress packets (i.e., packets from the LAN to a destination of the VPN), the method in the CPE device comprises establishing an IPSec tunnel with Forward Error Correction (FEC) between the CPE device and a Cloud Firewall (CFW) (130, 530) associated with the PE Router (the CFW and PE router can be distinct devices or integrated into a single device); receiving a plurality of egress packets from a Local Area Network (LAN), each of the egress packets comprising an Internet Protocol (IP) header and data payload, wherein the IP header identifies a destination address associated with the VPN; opening a data session and encapsulating each of the egress packets utilizing an encapsulation protocol to create encapsulated egress packets; encrypting each encapsulated egress packet to create encrypted encapsulated egress packets for transmission through the IPSec tunnel to the CFW; and, generating and transmitting Forward Error Correction (FEC) packets, together with the encrypted encapsulated egress packets, from the CPE device to the CFW. In a general corresponding embodiment, the method in a CFW, which includes or is associated with a PE router, comprises utilizing the FEC packets to reconstruct any missing encrypted encapsulated egress packets; decrypting the encrypted encapsulated egress packets; and, opening a data session and forwarding ones of the plurality of egress packets to the PE for routing to the destination address of the VPN.

For ingress packets (i.e., packets from the VPN to a destination of the LAN), the method in the PE router and/or associated CFW comprises receiving a plurality of ingress packets from the VPN, each of the ingress packets comprising an IP header and data payload, the IP header identifying a destination address associated with the LAN; encapsulating each of the ingress packets utilizing the encapsulation protocol to create encapsulated ingress; encrypting each encapsulated ingress packet to create encrypted encapsulated ingress packets for transmission through an IPSec tunnel from the CFW to the CPE; and, generating and transmitting FEC packets, together with the encrypted encapsulated ingress packets, from the CFW to the CPE. In a corresponding embodiment, the method in the CPE further comprises receiving the plurality of encrypted encapsulated ingress packets via an IPSec tunnel; receiving the FEC packets, together with the encrypted encapsulated ingress packets; utilizing the FEC packets to reconstruct any missing encrypted encapsulated packets; decrypting the encrypted encapsulated ingress packets; and, opening a data session and forwarding ones of the plurality of ingress packets to their associated destination address(es) of the LAN.

In a first exemplary embodiment, the encapsulation protocol is Generic Routing Encapsulation (GRE), wherein GRE encapsulation comprises adding a second IP header and GRE header to each packet. In a related embodiment, each of the encrypted encapsulated packets comprises the GRE encapsulated packet, a third IP header, an Encapsulating Security Payload (ESP) header, an ESP trailer, and ESP authentication information. In a second exemplary embodiment, the encapsulation protocol is Virtual Extensible LAN (VXLAN), wherein VXLAN encapsulation of each of the packets comprises adding a VXLAN header, a second IP header, a User Datagram Protocol (UDP) header, and an Ethernet header to each packet.

### BRIEF DESCRIPTION OF THE FIGURES

FIG. 1 illustrates a first exemplary network architecture in which a first solution utilizing the principles of the invention can be implemented;

FIG. 2 illustrates methods of operation in the network elements of the first exemplary network architecture for egress packet flows;

FIG. 3 illustrates methods of operation in the network elements of the first exemplary network architecture for ingress packet flows;

FIG. 4 illustrates first exemplary packet formats utilized by the systems and methods illustrated in FIGS. 1-3;

FIG. 5 illustrates a second exemplary network architecture in which a second solution utilizing the principles of the invention can be implemented;

FIG. 6 illustrates methods of operation in the network elements of the second exemplary network architecture for egress packet flows;

FIG. 7 illustrates methods of operation in the network elements of the second exemplary network architecture for ingress packet flows; and,

FIG. 8 illustrates second exemplary packet formats utilized by the systems and methods illustrated in FIGS. 5-7.

### DETAILED DESCRIPTION

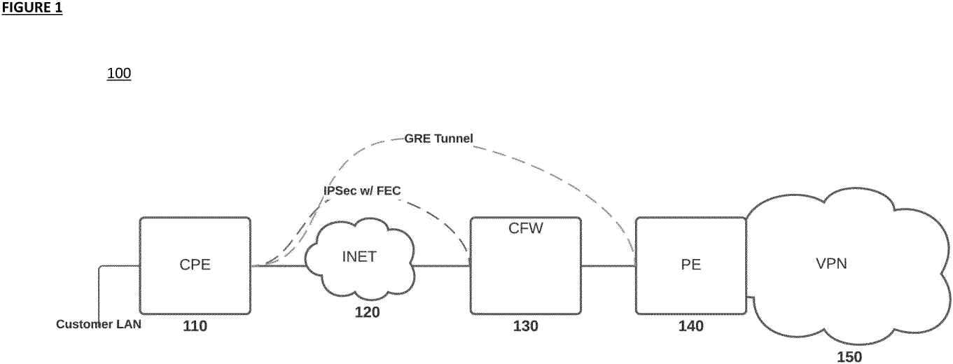

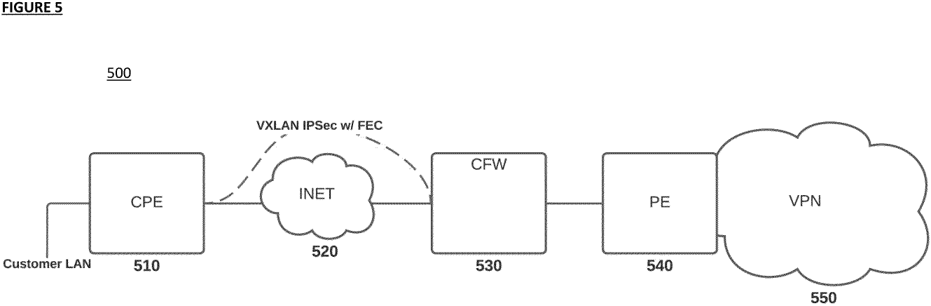

The principles of the invention(s) disclosed herein can be implemented in various network architectures to provide enterprise VPN services with broadband access that meets the Quality of Service (QoS) expectations associated with EPL. A first GRE solution is illustrated and described with reference to FIGS. 1-4 and a second VXLAN solution is illustrated and described with reference to FIGS. 5-8.

### GRE Solution

FIG. 1 illustrates an exemplary embodiment of a first network architecture 100, which comprises Customer Premises Equipment (CPE) 110, Internet 120, Cloud Firewall (CFW) 130, and Provider Edge (PE) Router 140. The Customer Premises Equipment 110 is a device installed at a customer (e.g., end-user) site which provides certain functions; namely, IPSec encryption, Generic Routing Encapsulation (GRE), session-based firewall, routing functionality, Software-Defined Wide Area Network (SD-WAN) functions and transmit/receive Forward Error Correction (FEC). The Cloud Firewall 130 device serves as the termination point for customer IPSec tunnels; it also provides the primary functions of session-based firewall, IPSec encryption, routing functions, and receive/transmit FEC packets. The PE Router 140 connects customer services with a virtual private network (VPN), such as a multi-protocol label switch (MPLS) network. According to the principles disclosed herein, the PE Router 140 functions as a GRE termination end-point, provides routing functions, and provides Quality-of-Service (QoS) for packets entering and leaving the VPN.

It should be noted that Cloud Firewall 130 and Provider Edge Router 140 are illustrated as distinct devices; those two devices, and the related functionality of each described hereinafter, however, can be integrated into a single physical device. Furthermore, although certain functionalities are described hereinafter as comprising one or more “steps”, such steps may be implemented as distinct sub-steps or as an integrated step comprising the associated functionality of multiple sub-steps; such alternative implementations that perform equivalent functionalities are intended to be within the scope of the disclosed principles of the invention.

### GRE Egress Operations

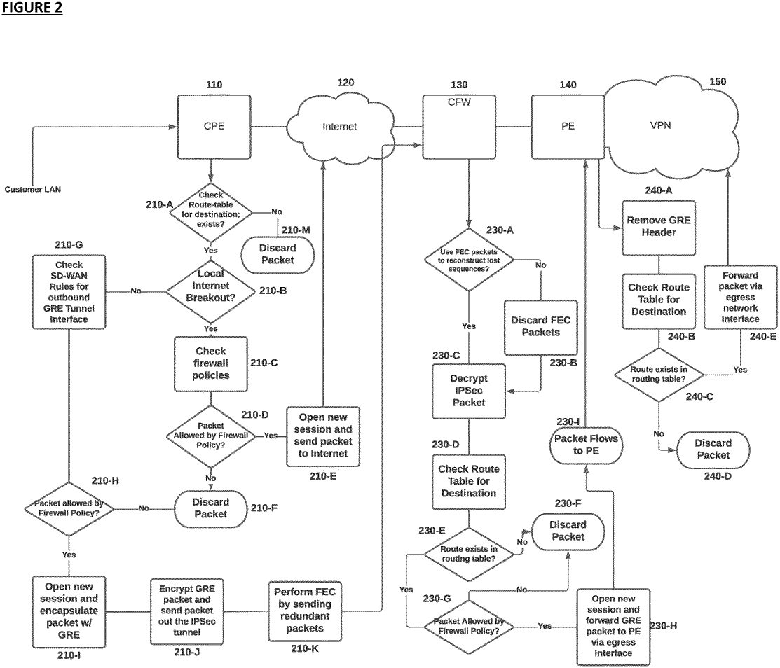

Turning now to FIG. 2, illustrated are exemplary methods of egress operation of the elements of network 100 that enable lossless broadband Virtual Private Network (VPN) access; the methods will be described separately with respect to the functionalities performed by the Customer Premises Equipment 110, Cloud Firewall 130, and Provider Edge Router 140. The “egress” processes described with reference to FIG. 2 relate to traffic flowing from a customer LAN via Customer Premises Equipment 110 to VPN 150.

### Customer Premises Equipment 110 Egress Functionality

A customer local area network (LAN) is coupled to Customer Premises Equipment 110; the Customer Premises Equipment receives data packets from the LAN, each of which identifies a destination Internet Protocol (IP) address. In a first step 210-A, a route-table lookup/check function is performed, wherein the destination IP address for each packet is checked against a route-table to match a route; the route can be any specific host route, part of a subnet, or even match the default-route. The route that matches also has a corresponding interface where the route is learned from. The learned route can be either a statically defined route or it can be learned from a routing protocol; a suitable routing protocol can be, for example, Border Gateway Protocol (BGP). To proceed, a valid route must exist to the destination IP of the packet; i.e., the route exists in the route-table with corresponding interface the route is learned from, or the route does not exist in the route-table. If no route to the destination exists in the table, the packet is discarded (step 210-M).

Next, in step 210-B, it is determined if a “Local Internet Breakout” exists; the criteria is whether a default-route egressing the local WAN interface exists (e.g., the route-table is checked to see if the default-route exists and if the local WAN interface is used). If the default-route exists and points to a local WAN interface, then firewall policies are checked in step 210-C; otherwise, processing moves to step 210-G (described infra).

In step 210-C, a Firewall Policy Check function is performed. The firewall policy explicitly allows packets from a source interface to a destination interface; the destination interface was determined as part of step 210-A, and the source interface identifies where the packet originated from on the LAN. Based on this source/destination interface pair, the firewall policies are checked in a top-down approach to match the first source/destination policy that matches the packets. A firewall policy can also contain other matching criteria, such as source IP address/subnet, destination IP address/subnet, source application port, destination application port, time-of-day schedule, source user/user group, specific protocols, or applications. If a packet matches all criteria within a policy, the action within the matching policy is performed, which is usually to allow the traffic; other firewall policy actions, for example, can be to allow packets and perform Network Address Translation (NAT) or deny/discard the packets.

If a packet matches all criteria of a firewall policy (step 210-D), it is allowed to proceed and, in step 210-D, a new session is allocated by the Customer Premises Equipment 110 and recorded in a session table (step 210-E) and the packet is forwarded to the Internet 120; the session table tracks all packets allowed and the corresponding firewall policy that allowed the traffic. Otherwise, if a packet is not allowed by a firewall policy, the packet triggers an implicit deny rule and is discarded (step 210-F).

Referring back to step 210-B, if a local internet breakout does not exist, processing proceeds to step 210-G, wherein SD-WAN rules are checked for an outbound GRE tunnel interface. SD-WAN rules are used to perform intelligent path control of packets. A packet can be forced across a certain transport (interface) in order to optimally use bandwidth of a given WAN, while other traffic can be load-balanced across any number of WAN transports. SD-WAN rules are similar to firewall rules in that they are processed in a top-down approach to find the first matching rule for a packet. The match criteria can be based, for example, on specific applications, source/destination IP, specific protocols, or ports. If no SD-WAN rules are matched, a default catch-all rule can be defined for all packets, which can either be load-balanced or sent out a primary interface first, with a backup interface used only when the primary interface is unavailable. If the packet matches all criteria within a rule, the packet will egress the destination interface specified in the rule. If no explicit match exists, the packet will match the catch-all rule, and the action is determined by the configuration, which can either be load-balancing, or primary/backup traffic method.

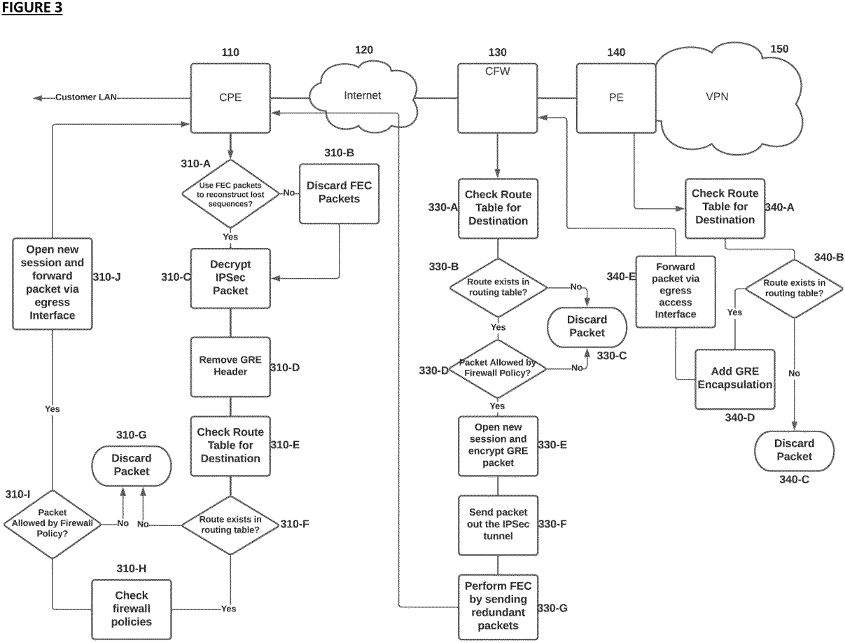

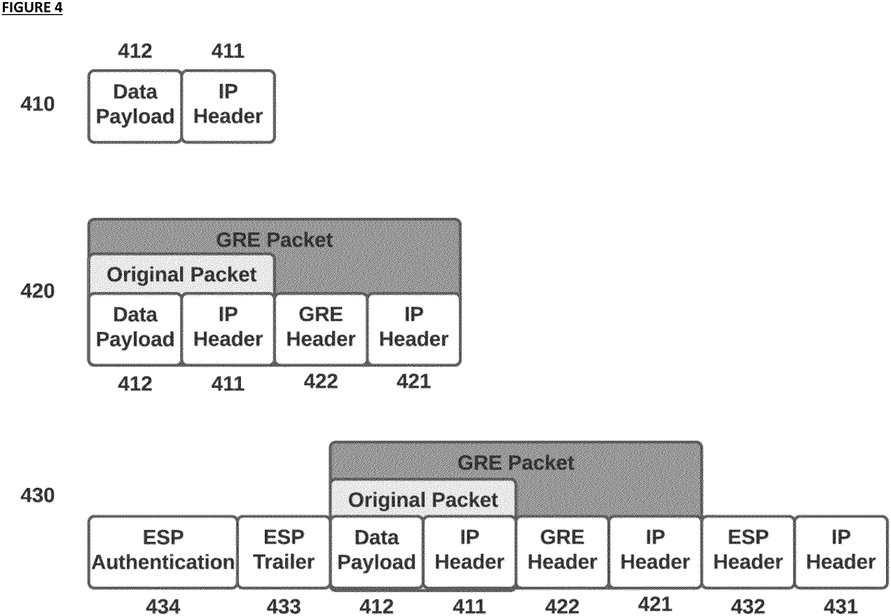

Next, in step 210-H, the packet is checked against the firewall policy; if not allowed, the packet is discarded (step 210-F), otherwise processing proceeds to step 210-1. In step 210-1, a new session is opened and the original packet 410 is encapsulated in a GRE packet 420, as illustrated in FIG. 4; i.e., the original packet 410 is now encapsulated with a GRE header 422 and another IP header 421 to be sent via a GRE tunnel to the Provider Edge Router 140 (via Internet 120 and Cloud Firewall 130). Furthermore, the GRE interface references the IPSec tunnel, so each GRE packet is encrypted and encapsulated with another IP header 431, an Encapsulating Security Payload (ESP) header 432, ESP trailer 433, and ESP authentication details 434 (see FIG. 4). Each encrypted GRE encapsulated packet is then sent via the IPSec tunnel to the Cloud Firewall 130 (via Internet 120). Finally, in step 210-K, Forward Error Correction (FEC) packets are generated to be sent across the interface along with the original packets (within the encrypted GRE encapsulated packet); the FEC packets contain sequence and data information from the original packets in order for the terminating device (i.e., Cloud Firewall 130) to be able to reconstruct any packets lost in transmission. On the ingress path (as will be described infra with respect to FIG. 3), the Customer Premises Equipment 110 can also reconstruct packets as the FEC function works on both egress and ingress traffic.

### Cloud Firewall 130 Egress Functionality

Turning now to the functionality of the Cloud Firewall 130, the process of handling packets received from the Internet 120 begins with step 230-A, wherein the firewall will check the packet sequence numbers to determine whether there are any missing sequences; if missing sequences are found, the packets will be reconstructed from information in the FEC packets. If there are no missing sequences, the FEC packets are discarded as there are no packet losses to overcome (step 230-B).

Next, in step 230-C, the firewall will remove the IPSec encapsulation from each incoming packet (i.e., elements 431, 432, 433 and 434 illustrated in FIG. 4) and proceed to check the route-table for the destination IP of the GRE packet (step 230-D). A valid route must exist to the destination IP for the packet; the route must exist in the route-table with corresponding interface the route is learned from, or the route does not exist in the route-table. In step 230-E, if the route exists, the learned interface is recorded as the egress interface and is used in the firewall policy check function; if the route does not exist, the packet is discarded (step 230-F). If the route exists, a firewall policy check is performed in step 230-G; either the packet will match a policy, or will not match a policy. Firewall policy match-criteria includes: source IP address/subnet, destination IP address/subnet, source application port, destination application port, time-of-day schedule, source user/user group, specific protocols or applications. If a packet matches all criteria within a policy, the packet is allowed to egress the destination interface (step 230-H); if no match exists, the packet is discarded by the implicit deny policy (step 230-F). If a packet is allowed by the firewall policy, a new session is allocated by the cloud firewall 130 and recorded in the session table (step 230-H); the session table tracks all packets allowed and the corresponding firewall policy that allowed the traffic. In step 230-1, the GRE packet is then forwarded to the Provider Edge (PE) Router 140.

### Provider Edge Router 140 Egress Functionality

Turning now to the functionality of the Provider Edge Router 140, the process of handling packets received from the Cloud Firewall 130 begins with step 240-A, wherein the router removes the GRE encapsulation (FIG. 4, elements 421, 422) from each incoming packet. Next, a route-table for the destination IP of the original packet (i.e., packet 410) is checked in step 240-B. If the route exists, the learned interface is recorded as the egress interface and is forwarded out the interface in step 240-E to VPN 150 for routing to the destination IP address of the original packet; otherwise, if the route does not exist, the packet is discarded in step 240-D.

### GRE Ingress Operations

Turning now to FIG. 3,illustrated are exemplary methods of ingress operation of the elements of network 100 that enable lossless broadband VPN access; the methods will be described separately with respect to the functionalities performed by the Provider Edge Router 140, Cloud Firewall 130, and Customer Premises Equipment 110. The “ingress” processes described with reference to FIG. 3 relate to traffic flowing from VPN 150 to a customer LAN via Customer Premises Equipment 110.

### Provider Edge Router 140 Ingress Functionality

The ingress packet flow process starts at the Provider Edge Router 140. When an original packet 410 arrives from VPN 150 at the Provider Edge Router 140, the first step is to check that a route exists in the route-table (step 340-A). If the route exists in the table, as determined in step 340-B, the router will add an extra GRE header and IP Header (FIG. 4, elements 421 and 422, respectively) to the packet in step 340-D; otherwise, the packet is discarded (step 340-C). Next, in step 340-E, the GRE encapsulated packet is forwarded to the Cloud Firewall 130 using the egress interface of the Provider Edge Router 140.

### Cloud Firewall 130 Ingress Functionality

Cloud Firewall 130 receives original packets 410 destined for the customer LAN from Provider Edge Router 140; the original packets have been GRE encapsulated by the Provider Edge Router 140, as described supra. In step 330-A, the route table is checked by the Cloud Firewall 130 for the destination IP address of a received packet. If no valid route exists in the table, as determined in step 330-B, the packet is discarded in step 330-C; if a route does exist, it is determined in step 330-D if the packet is allowed by a firewall policy. If the packet is not allowed by a firewall policy, the packet triggers an implicit deny and the packet is discarded (step 330-C). If the packet is allowed by a firewall policy, a new session is opened and recorded in the session table and the GRE encapsulated packet is encrypted (step 330-E); the encryption adds an extra IP header, ESP header, ESP trailer, and ESP authentication (FIG. 4, elements 431, 432, 433, and 434, respectively) to the GRE encapsulated original packet. Next, in step 330-F, the encrypted GRE packet is forwarded to the Customer Premises Equipment 110 via an IPsec tunnel through Internet 120. In addition, in step 330-G, the Cloud Firewall 130 also sends FEC packets with information about sequencing and data in order for Customer Premises Equipment 110 to reconstruct any lost packets.

### Customer Premises Equipment 110 Ingress Functionality

Each encrypted GRE encapsulated packet, and associated FEC packets, arrive at the Customer Premises Equipment 110 from Cloud Firewall 130, via Internet 120. Upon arrival, in step 310-A, it is determined if any lost packets need to be reconstructed from the FEC packets. If all packets arrived, then the FEC packets can be discarded in step 310-B; otherwise, if there are missing sequences, the FEC packets are used to reconstruct the lost packets. Next, in step 310-C, the IPSec encapsulation is removed from the GRE encapsulated packet; i.e., elements 431, 432, 433, and 434, as illustrated in FIG. 4. Next, in step 310-D, the GRE encapsulation is removed (FIG. 4, elements 421 and 422), leaving the original packet from VPN 150. In step 310-E, a route-table is checked for a valid route to the destination IP address on the customer LAN. If the route does not exist, as determined in step 310-F, the packet will be discarded (step 310-G). If the route does exist, firewall policies are checked (step 310-H). If the packet is not allowed by a firewall policy, as determined in step 310-1, it is discarded (step 310-G); otherwise, in step 310-J, Customer Premises Equipment 110 will open a new session, record the session in its session table, and forward the packet to the customer LAN via the Customer Premises Equipment 110 egress interface.

### VXLAN Solution

FIG. 5 illustrates an exemplary embodiment of a second network architecture 500, which comprises Customer Premises Equipment (CPE) 510, Internet 520, Cloud Firewall (CFW) 530, and Provider Edge (PE) Router 540. The Customer Premises Equipment 510 is a device installed at a customer (e.g., end-user) site which provides certain functions; namely, IPSec encryption, VXLAN encapsulation/decapsulation, session-based firewall, routing functionality, Software-Defined Wide Area Network (SD-WAN) functions and transmit/receive Forward Error Correction (FEC). The Cloud Firewall 530 device serves as the termination point for customer IPSec tunnels; it also provides the primary functions of session-based firewall, IPSec encryption, routing functions, VXLAN encapsulation/decapsulation, and receive/transmit FEC packets. The PE Router 540 connects customer services with a virtual private network (VPN), such as a multi-protocol label switch (MPLS) network. According to the principles disclosed herein, the PE Router 540 provides routing functions, and provides Quality-of-Service (QoS) for packets entering and leaving the VPN.

It should be noted that Cloud Firewall 530 and Provider Edge Router 540 are illustrated as distinct devices; those two devices, and the related functionality of each described hereinafter, however, can be integrated into a single physical device. Furthermore, although certain functionalities are described hereinafter as comprising one or more “steps”, such steps may be implemented as distinct sub-steps or as an integrated step comprising the associated functionality of multiple sub-steps; such alternative implementations that perform equivalent functionalities are intended to be within the scope of the disclosed principles of the invention.

### VXLAN Egress Operations

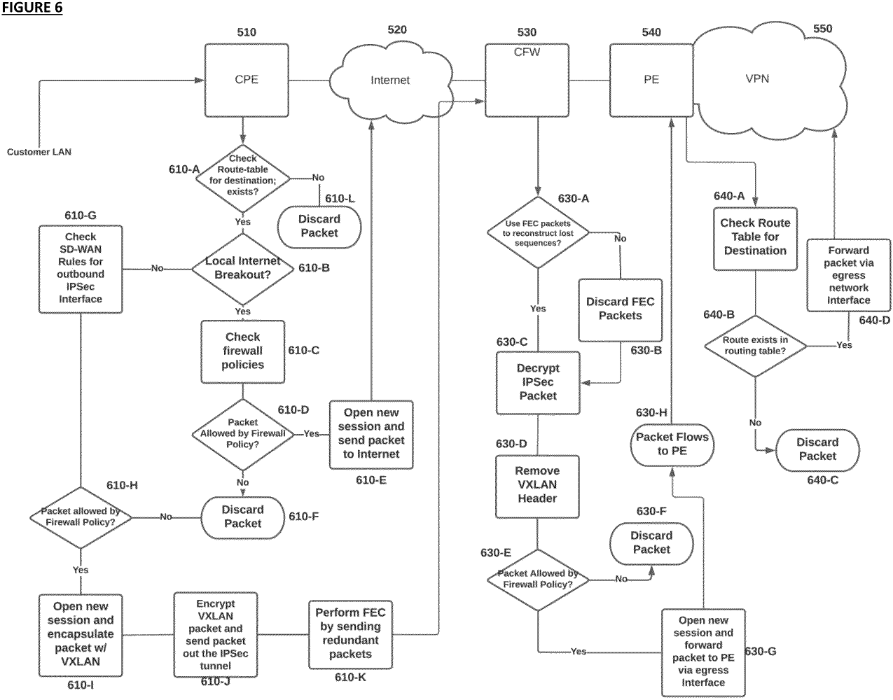

Turning now to FIG. 6, illustrated are exemplary methods of egress operation of the elements of network 500 that enable lossless broadband Virtual Private Network (VPN) access; the methods will be described separately with respect to the functionalities performed by the Customer Premises Equipment 510, Cloud Firewall 530, and Provider Edge Router 540. The “egress” processes described with reference to FIG. 6 relate to traffic flowing from a customer LAN via Customer Premises Equipment 510 to VPN 550.

### Customer Premises Equipment 510 Egress Functionality

A customer local area network (LAN) is coupled to Customer Premises Equipment 510; the Customer Premises Equipment receives data packets from the LAN, each of which identifies a destination Internet Protocol (IP) address. In a first step 610-A, a route-table lookup/check function is performed, wherein the destination IP address for each packet is checked against a route-table to match a route; the route can be any specific host route, part of a subnet, or even match the default-route. The route that matches also has a corresponding interface where the route is learned from. The learned route can be either a statically defined route or it can be learned from a routing protocol; a suitable routing protocol can be, for example, Border Gateway Protocol (BGP). To proceed, a valid route must exist to the destination IP of the packet; i.e., the route exists in the route-table with corresponding interface the route is learned from, or the route does not exist in the route-table. If no route to the destination exists in the table, the packet is discarded (step 610-L).

Next, in step 610-B, it is determined if a “Local Internet Breakout” exists; the criteria is whether a default-route egressing the local WAN interface exists (e.g., the route-table is checked to see if the default-route exists and if the local WAN interface is used). If the default-route exists and points to a local WAN interface, then firewall policies are checked in step 610-C; otherwise, processing moves to step 610-G (described infra).

In step 610-C, a Firewall Policy Check function is performed. The firewall policy explicitly allows packets from a source interface to a destination interface; the destination interface was determined as part of step 610-A, and the source interface identifies where the packet originated from on the LAN. Based on this source/destination interface pair, the firewall policies are checked in a top-down approach to match the first source/destination policy that matches the packets. A firewall policy can also contain other matching criteria, such as source IP address/subnet, destination IP address/subnet, source application port, destination application port, time-of-day schedule, source user/user group, specific protocols, or applications. If a packet matches all criteria within a policy, the action within the matching policy is performed, which is usually to allow the traffic; other firewall policy actions, for example, can be to allow packets and perform Network Address Translation (NAT) or deny/discard the packets.

If a packet matches all criteria of a firewall policy (step 610-D), it is allowed to proceed and, in step 610-D, a new session is allocated by the Customer Premises Equipment 510 and recorded in a session table (step 610-E) and the packet is forwarded to the Internet 520; the session table tracks all packets allowed and the corresponding firewall policy that allowed the traffic. Otherwise, if a packet is not allowed by a firewall policy, the packet triggers an implicit deny rule and is discarded (step 610-F).

Referring back to step 610-B, if a local internet breakout does not exist, processing proceeds to step 610-G, wherein SD-WAN rules are checked for an outbound IPSec tunnel interface. SD-WAN rules are used to perform intelligent path control of packets. A packet can be forced across a certain transport (interface) in order to optimally use bandwidth of a given WAN, while other traffic can be load-balanced across any number of WAN transports. SD-WAN rules are similar to firewall rules in that they are processed in a top-down approach to find the first matching rule for a packet. The match criteria can be based, for example, on specific applications, source/destination IP, specific protocols, or ports. If no SD-WAN rules are matched, a default catch-all rule can be defined for all packets, which can either be load-balanced or sent out a primary interface first, with a backup interface used only when the primary interface is unavailable. If the packet matches all criteria within a rule, the packet will egress the destination interface specified in the rule. If no explicit match exists, the packet will match the catch-all rule, and the action is determined by the configuration, which can either be load-balancing, or primary/backup traffic method.

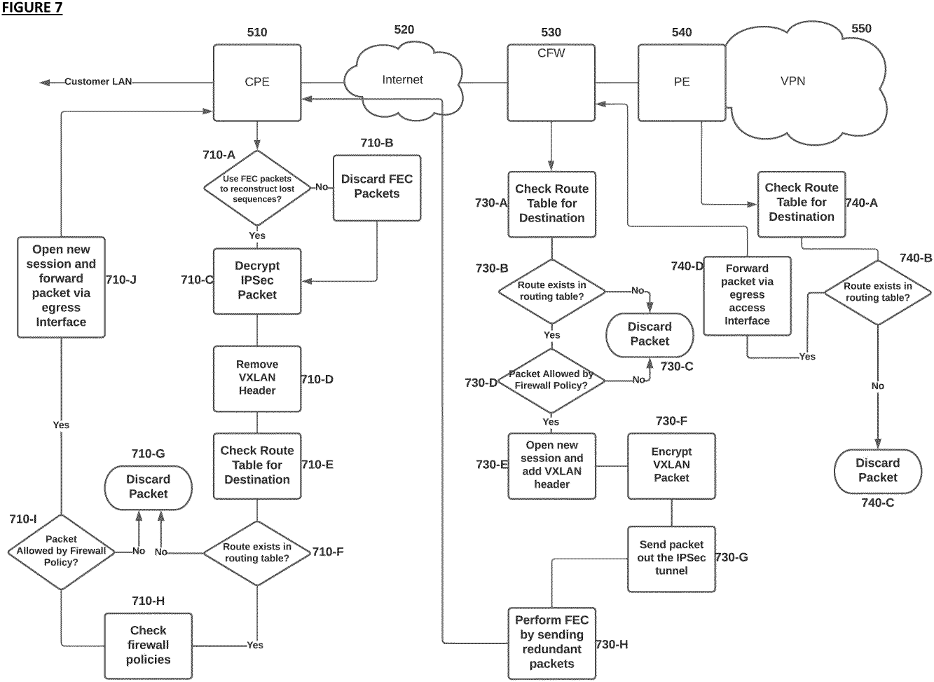

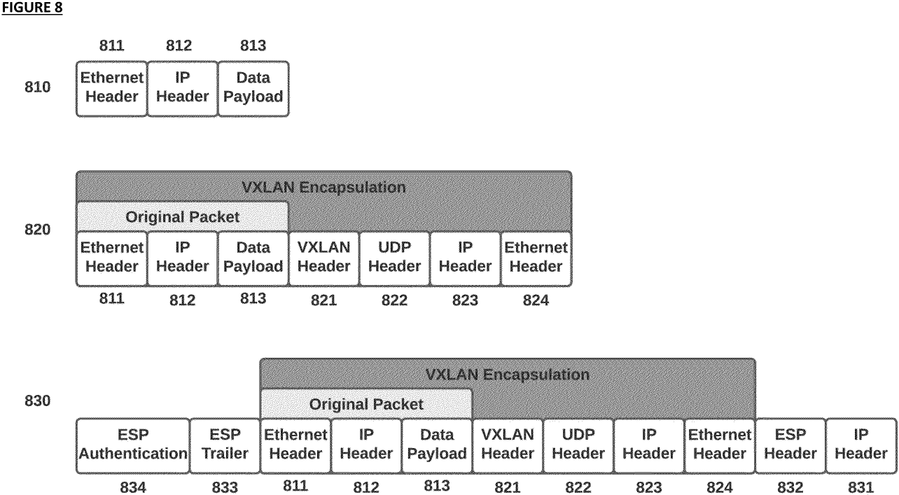

Next, in step 610-H, the packet is checked against the firewall policy; if not allowed, the packet is discarded (step 610-F), otherwise processing proceeds to step 610-1. In step 610-1, a new session is opened and the original packet 810 is encapsulated in a VXLAN header 820, as illustrated in FIG. 8; i.e., the original packet 810 is now encapsulated with a VXLAN header 821, another IP header 823, a UDP header 822, and an Ethernet Header 824 to be sent via an IPSec tunnel to the Cloud firewall 530 (via Internet 520). Furthermore, the VXLAN configuration references the IPSec tunnel, so each VXLAN packet is encrypted and encapsulated with an Encapsulating Security Payload (ESP) header 832, ESP trailer 833, and ESP authentication details 834 (see FIG. 8). Each encrypted VXLAN encapsulated packet is then sent via the IPSec tunnel to the Cloud Firewall 530 (via Internet 520). Finally, in step 610-K, Forward Error Correction (FEC) packets are generated to be sent across the interface along with the original packets (within the encrypted VXLAN encapsulated packet); the FEC packets contain sequence and data information from the original packets in order for the terminating device (i.e., Cloud Firewall 530) to be able to reconstruct any packets lost in transmission. On the ingress path (as will be described infra with respect to FIG. 7), the Customer Premises Equipment 510 can also reconstruct packets as the FEC function works on both egress and ingress traffic.

### Cloud Firewall 530 Egress Functionality

Turning now to the functionality of the Cloud Firewall 530, the process of handling packets received from the Internet 520 begins with step 630-A, wherein the firewall will check the packet sequence numbers to determine whether there are any missing sequences; if missing sequences are found, the packets will be reconstructed from information in the FEC packets. If there are no missing sequences, the FEC packets are discarded as there are no packet losses to overcome (step 630-B).

Next, in step 630-C, the firewall will remove the IPSec encapsulation from each incoming packet (i.e., elements 831, 832, 833 and 834 illustrated in FIG. 8). Also, in step 630-D, the VXLAN encapsulation will be removed from each incoming packet (i.e, elements 821, 822, 823, and 824 illustrated in FIG. 8). A firewall policy check is performed in step 630-E; either the packet will match a policy, or will not match a policy. Firewall policy match-criteria includes: source IP address/subnet, destination IP address/subnet, source application port, destination application port, time-of-day schedule, source user/user group, specific protocols or applications. If a packet matches all criteria within a policy, the packet is allowed to egress the destination interface (step 630-G); if no match exists, the packet is discarded by the implicit deny policy (step 630-F). If a packet is allowed by the firewall policy, a new session is allocated by the cloud firewall 530 and recorded in the session table (step 630-G); the session table tracks all packets allowed and the corresponding firewall policy that allowed the traffic. In step 630-H, the original packet is then forwarded to the Provider Edge (PE) Router 540.

### Provider Edge Router 540 Egress Functionality

Turning now to the functionality of the Provider Edge Router 540, the process of handling packets received from the Cloud Firewall 530 begins with step 640-A, wherein the router receives the original packet (FIG. 8, elements 811, 812, 813). Next, a route-table for the destination IP of the original packet (i.e., packet 810) is checked in step 640-B. If the route exists, the learned interface is recorded as the egress interface and is forwarded out the interface in step 640-D to VPN 550 for routing to the destination IP address of the original packet; otherwise, if the route does not exist, the packet is discarded in step 640-C.

### VXLAN Ingress Operations

Turning now to FIG. 7, illustrated are exemplary methods of ingress operation of the elements of network 500 that enable lossless broadband VPN access; the methods will be described separately with respect to the functionalities performed by the Provider Edge Router 540, Cloud Firewall 530, and Customer Premises Equipment 510. The “ingress” processes described with reference to FIG. 7 relate to traffic flowing from VPN 550 to a customer LAN via Customer Premises Equipment 510.

### Provider Edge Router 540 Ingress Functionality

The ingress packet flow process starts at the Provider Edge Router 540. When an original packet 810 arrives from VPN 550 at the Provider Edge Router 540, the first step is to check that a route exists in the route-table (step 740-A). If the route exists in the table, as determined in step 740-B, the router will forward the packet to the Cloud Firewall 530 using the egress interface of the Provider Edge Router 540 as shown in step 740-D; otherwise, the packet is discarded (step 740-C).

### Cloud Firewall 530 Ingress Functionality

Cloud Firewall 530 receives original packets 810 destined for the customer LAN from Provider Edge Router 540. In step 730-A, the route table is checked by the Cloud Firewall 530 for the destination IP address of a received packet. If no valid route exists in the table, as determined in step 730-B, the packet is discarded in step 730-C; if a route does exist, it is determined in step 730-D if the packet is allowed by a firewall policy. If the packet is not allowed by a firewall policy, the packet triggers an implicit deny and the packet is discarded (step 730-C). If the packet is allowed by a firewall policy, a new session is opened and recorded in the session table and the original packet is encapsulated (step 730-E) with a VXLAN header 821, an IP header 823, a UDP header 822, and an Ethernet header 824. Next, the packet is encrypted (step 730-F); the encryption adds an extra IP header, ESP header, ESP trailer, and ESP authentication (FIG. 8, elements 831, 832, 833, and 834, respectively) to the VXLAN encapsulated packet. Next, in step 730-G, the encrypted VXLAN packet is forwarded to the Customer Premises Equipment 510 via an IPsec tunnel through Internet 520. In addition, in step 730-H, the Cloud Firewall 530 also sends FEC packets with information about sequencing and data in order for Customer Premises Equipment 510 to reconstruct any lost packets.

### Customer Premises Equipment 510 Ingress Functionality

Each encrypted VXLAN encapsulated packet, and associated FEC packets, arrive at the Customer Premises Equipment 510 from Cloud Firewall 530, via Internet 520. Upon arrival, in step 710-A, it is determined if any lost packets need to be reconstructed from the FEC packets. If all packets arrived, then the FEC packets can be discarded in step 710-B; otherwise, if there are missing sequences, the FEC packets are used to reconstruct the lost packets. Next, in step 710-C, the IPSec encapsulation is removed from the VXLAN encapsulated packet; i.e., elements 831, 832, 833, and 834, as illustrated in FIG. 8. Next, in step 710-D, the VXLAN encapsulation is removed (FIG. 8, elements 821, 822, 823, and 824), leaving the original packet from VPN 550. In step 710-E, a route-table is checked for a valid route to the destination IP address on the customer LAN. If the route does not exist, as determined in step 710-F, the packet will be discarded (step 710-G). If the route does exist, firewall policies are checked (step 710-H). If the packet is not allowed by a firewall policy, as determined in step 710-I, it is discarded (step 710-G); otherwise, in step 710-J, Customer Premises Equipment 510 will open a new session, record the session in its session table, and forward the packet to the customer LAN via the Customer Premises Equipment 510 egress interface.

### Machine Learning /Artificial Intelligence Optimizations

The systems and methods disclosed herein, hereinafter referred to as “Performance Edge™”, can be optimized through machine-learning and/or artificial intelligence methods and algorithms. For example:
Performance Edge can be turned on and off automatically with load detection to optimize available bandwidth, for example:
   Upon detecting packet loss, if not enabled, Performance Edge can be enabled with a configured default capacity to buffer packets;
   Total link throughput capacity can have a set of high and low watermarks to enable Performance Edge on or off implicitly.
Allocated packet buffer size (e._{g}., 10x the buffered packets by default) can be tuned based on increasing/decreasing traffic trend of real-time or managed applications.
Performance Edge can be automatically or manually enabled (upon notification) based on traffic baselining and/or normalization, and can be regularly audited while in operation to tune the buffer and/or switch it off. Similarly, Performance Edge sites can be audited to enable it when traffic trends up, is manually switched on (go “turbo”), or turned off when traffic falls below a configurable threshold or percentage of total capacity.
Notifications can be provided to inform the user to enable Performance Edge if either (a) packet loss is regular for real-time apps, and (b) real-time traffic spike predictions including metrics, for example, on such spikes over the last 1, 7, 14, and 30 days.
Analytics experience to the user can show Performance Edge in operation (how often it came on for example) in the background, including buffered packet rates and resulting Quality of Experience (QoE) trend (e.g., packet loss violation count below acceptable limits).

The foregoing has described technical principles that can be implemented to provide enterprise VPN services with broadband access that meet the Quality of Service (QoS) expectations associated with EPL. The principles of the invention are adaptable to various network architectures and protocols, as illustrated by the exemplary GRE and VXLAN solutions described herein; the principles of the invention, however, are not limited to GRE and VXLAN and can be adapted for use with other network architectures and protocols.

We claim:

1. A method to provide lossless broadband communications, via the Internet (120, 520), between a Customer Premises Equipment (CPE) device (110, 510) and a Provider Edge (PE) Router (140, 540) associated with a Virtual Private Network (150, 550), said method comprising the steps of:
establishing an IPSec tunnel with Forward Error Correction (FEC) between said CPE and a Cloud Firewall (CFW) (130, 530) associated with said PE Router;
receiving, by said CPE, a plurality of egress packets from a Local Area Network (LAN), each of said egress packets comprising an Internet Protocol (IP) header and data payload, said IP header identifying a destination address associated with said VPN;
opening a data session and encapsulating each of said egress packets utilizing an encapsulation protocol to create encapsulated egress packets (210-I, 610-1);
encrypting each encapsulated egress packet to create encrypted encapsulated egress packets for transmission through said IPSec tunnel from said CPE to said CFW (210-J, 610-J);
generating and transmitting Forward Error Correction (FEC) packets, together with said encrypted encapsulated egress packets, from said CPE to said CFW (210-K, 610-K);
utilizing said FEC packets, by said CFW, to reconstruct any missing encrypted encapsulated egress packets (230-A, 630-A);
decrypting, by said CFW, said encrypted encapsulated egress packets (230-C, 630-C); and,
opening a data session by said CFW and forwarding ones of said plurality of egress packets to said PE for routing to said destination address of said VPN (230-H, 630-G).

2. The method recited in claim 1, wherein said encapsulation protocol is Generic Routing Encapsulation (GRE), wherein GRE encapsulation of each of said egress packets comprises adding a second IP header and GRE header to each packet.

3. The method recited in claim 2, wherein said egress packets forwarded by said CFW to said PE comprise said GRE encapsulated egress packets.

4. The method recited in claim 3, wherein each of said encrypted encapsulated egress packets comprises a GRE encapsulated packet, a third IP header, an Encapsulating Security Payload (ESP) header, an ESP trailer, and ESP authentication information.

5. The method recited in claim 4, further comprising the step of removing said GRE encapsulation from each egress packet received by said PE prior to forwarding to said destination address (230-A).

6. The method recited in claim 1, wherein said encapsulation protocol is Virtual Extensible LAN (VXLAN), wherein VXLAN encapsulation of each of said egress packets comprises adding a VXLAN header, a second IP header, a User Datagram Protocol (UDP) header, and an Ethernet header to each egress packet.

7. The method recited in claim 6, further comprising the step of removing said VXLAN encapsulation by said CFW (630-D) prior to said step of forwarding to said PE for routing to said destination address of said VPN.

8. The method recited in claim 1, further comprising the steps of:
receiving, by said PE, a plurality of ingress packets from said VPN, each of said ingress packets comprising an IP header and data payload, said IP header identifying a destination address associated with said LAN;
encapsulating each of said ingress packets utilizing said encapsulation protocol to create encapsulated ingress packets (340-D, 730-E);
encrypting each encapsulated ingress packet to create encrypted encapsulated ingress packets (330-E, 730-F) for transmission through said IPSec tunnel from said CFW to said CPE;
generating and transmitting FEC packets (330-G, 730-H), together with said encrypted encapsulated ingress packets, from said CFW to said CPE;
utilizing said FEC packets, by said CPE, to reconstruct any missing encrypted encapsulated packets (310-A, 710-A);
decrypting, by said CPE, said encrypted encapsulated ingress packets (310-C, 710-C); and,
opening a data session by said CPE and forwarding ones of said plurality of ingress packets to its associated destination address of said LAN (310-J, 710-J).

9. The method recited in claim 8, wherein said step of encapsulating each of said ingress packets is performed by said PE.

10. The method recited in claim 8, wherein said step of encrypting each encapsulated ingress packet is performed by said CFW.

11. The method recited in claim 8, further comprising the step of removing said encapsulation from each of said ingress packets (310-D, 710-D), by said CPE, prior to forwarding to said destination address of said LAN.

12. A method in a Customer Premises Equipment (CPE) device to provide lossless broadband communications, via the Internet (120, 520), between said CPE device (110, 510) and a Provider Edge (PE) Router (140, 540) associated with a Virtual Private Network (150, 550), said method comprising the steps of:
establishing an IPSec tunnel with Forward Error Correction (FEC) between said CPE device and a Cloud Firewall (CFW) (130, 530) associated with said PE Router;
receiving, by said CPE, a plurality of egress packets from a Local Area Network (LAN), each of said egress packets comprising an Internet Protocol (IP) header and data payload, said IP header identifying a destination address associated with said VPN;
opening a data session and encapsulating each of said egress packets utilizing an encapsulation protocol to create encapsulated egress packets (210-I, 610-I);
encrypting each encapsulated egress packet to create encrypted encapsulated egress packets for transmission through said IPSec tunnel from said CPE to said CFW (210-J, 610-J); and,
generating and transmitting Forward Error Correction (FEC) packets, together with said encrypted encapsulated egress packets, from said CPE to said CFW (210-K, 610-K).

13. The method recited in claim 12, wherein said encapsulation protocol is Generic Routing Encapsulation (GRE), wherein GRE encapsulation of each of said egress packets comprises adding a second IP header and GRE header to each packet.

14. The method recited in claim 13, wherein each of said encrypted encapsulated egress packets comprises a GRE encapsulated packet, a third IP header, an Encapsulating Security Payload (ESP) header, an ESP trailer, and ESP authentication information.

15. The method recited in claim 12, wherein said encapsulation protocol is Virtual Extensible LAN (VXLAN), wherein VXLAN encapsulation of each of said egress packets comprises adding a VXLAN header, a second IP header, a User Datagram Protocol (UDP) header, and an Ethernet header to each egress packet.

16. The method recited in claim 12, further comprising the steps of:
receiving a plurality of encrypted encapsulated ingress packets via an IPSec tunnel, each of said ingress packets comprising an IP header and data payload, said IP header identifying a destination address associated with said LAN (330-F);
receiving FEC packets (330-G, 730-H), together with said encrypted encapsulated ingress packets;
utilizing said FEC packets to reconstruct any missing encrypted encapsulated packets (310-A, 710-A);
decrypting said encrypted encapsulated ingress packets (310-C, 710-C); and,
opening a data session and forwarding ones of said plurality of ingress packets to its associated destination address of said LAN (310-J, 710-J).

17. The method recited in claim 16, further comprising the step of removing said encapsulation from each of said ingress packets (310-D, 710-D) prior to forwarding to said destination address of said LAN.

18. A method in a Provider Edge (PE) router (140, 540) associated with a Virtual Private Network (150, 550) to provide lossless broadband communications, via the Internet (120, 520), between said PE router and a Customer Premises Equipment (CPE) device (110, 510), wherein said PE router includes a Cloud Firewall (CFW), said method comprising the steps of:
receiving, by said PE router, a plurality of ingress packets from said VPN, each of said ingress packets comprising an IP header and data payload, said IP header identifying a destination address associated with said LAN;
encapsulating each of said ingress packets utilizing an encapsulation protocol to create encapsulated ingress packets (340-D, 730-E);
encrypting each encapsulated ingress packet to create encrypted encapsulated ingress packets (330-E, 730-F) for transmission through an IPSec tunnel from said CFW to said CPE; and,
generating and transmitting FEC packets (330-G, 730-H), together with said encrypted encapsulated ingress packets, from said CFW to said CPE.

19. The method recited in claim 18, wherein said encapsulation protocol is Generic Routing Encapsulation (GRE), wherein GRE encapsulation of each of said egress packets comprises adding a second IP header and GRE header to each packet.

20. The method recited in claim 18, wherein said encapsulation protocol is Virtual Extensible LAN (VXLAN), wherein VXLAN encapsulation of each of said egress packets comprises adding a VXLAN header, a second IP header, a User Datagram Protocol (UDP) header, and an Ethernet header to each egress packet.
